(19) United States
(12) Patent Application Publication
(10) Pub. No.: US 2003/0177630 A1
(43) Pub. Date: Sep. 25, 2003

(54) Method for producing an electromagnetic actuator

(76) Inventors: Sonja Herold, Althuette (DE); Thomas Stolk, Kirchheim (DE); Alexander Von Gaisberg, Fellbach (DE)

Correspondence Address: FASSE PATENT ATTORNEYS, P.A., P.O. BOX 726, HAMPDEN, ME, 04444-0726, US

(21) Appl. No.: 10/344,504

(22) PCT Filed: Oct. 2, 2001
(86) PCT No.: PCT/EP01/11374

(30) Foreign Application Priority Data
Oct. 14, 2000 (DE) 100 51 076.0

(51) Int. Cl. H01F 7/06

(52) U.S. Cl. 29/602.1; 29/888.03; 29/607

(57) ABSTRACT

A known electromagnetic actuator comprises two electromagnets arranged opposite one another, an armature that is movable back and forth between the electromagnets against the force of two mutually counteracting springs, as well as adjusting means for adjusting the idle or rest position of the armature. In this regard, it is shown to be disadvantageous, that after several hours of operation a readjustment of the pre-tension of the springs determining the rest position may be necessary. The new method is to enable an adjustment of the pre-tension of the springs that is durable and optimal for the operation of the actuator. This is achieved in that the springs are compressed in repeating compression cycles so often until the energy respectively stored therein due to their compression no longer or only insignificantly differs from the energy stored in the respective spring in a preceding compression cycle, and in that the adjustment of the pre-tension of the springs is only carried out thereafter. Production of an electromagnetic actuator for controlling the gas exchange in an internal combustion engine.

The invention relates to a method for producing an electromagnetic actuator according to the preamble of the patent claim 1.

An electromagnetic actuator for operating a gas exchange valve in an internal combustion engine is known from the DE 196 31 909 A1. The previously known actuator comprises two electromagnets arranged at a spacing distance relative to each other, and an armature that is operatively connected with the gas exchange valve, and that is movable back and forth between the electromagnets due to magnetic force, against the force of a spring arrangement of two mutually counteracting springs. The actuator further comprises adjusting means, with which the idle or resting position of the armature, that is to say the position of the armature with unenergized current-less electromagnets, is adjusted to the geometric center between the two end positions of the armature. In this context it is found to be disadvantageous, that the resting position can become shifted during the operation, so that after several hours of operation, a readjustment of the resting position is necessary.

From the DE 199 27 823, which is not previously published, an electromagnetic actuator of the initially mentioned type is known, in which the pre-tensioning of the springs is adjusted in such a manner, so that the same energy is stored in the springs due to the compression of the springs resulting from the armature motion.

It is the object underlying the invention to specify a method according to the preamble of the patent claim 1, which enables an adjustment of the pre-tension of the springs that is durable and optimal for the operation of the actuator.

The object is achieved by the characterizing features of the patent claim 1. Advantageous embodiments and further developments arise from the dependent claims.

According to the invention, an electromagnetic actuator, which comprises two electromagnets arranged at a spacing distance relative to one another, and an armature that is movable back and forth between the electromagnets against the force of two oppositely acting springs, is placed into operation in two successive method steps. In the first method step, the springs are respectively compressed by a certain compression value in repeating compression cycles, so often until the energy, which is stored therein due to their compression, no longer or only insignificantly differs from the energy stored in the respective spring in a preceding compression cycle. Then, in a subsequent method step, an adjustment of the pre-tension of the one spring or of both springs is carried out.

Preferably, the compression value is selected to be equal to the value by which the springs are compressed during the specified operation of the actuator.

The goal of the first method step is to achieve and recognize, as much as possible, a complete setting or settling of the springs and parts of the actuator that move together with the armature. In this context, by the term setting or settling of the springs and of the moved parts of the actuator, one understands a change of the pre-tension of the springs or of the dimensions of the moved parts of the actuator, which results from the operationally caused relaxation phenomena or manifestations in the material structure or grain of the springs and the utilized components. The first method step thus leads to a stationary operating condition, in which the spring characteristics no longer change or only insignificantly change with an increasing number of compression cycles, that is to say with an increasing number of operating hours. Due to the adjustment of the pre-tension of one of the two springs or of both springs, which is carried out only in the subsequent method step, one achieves that setting or settling effects no longer play any role in the following operation and thus also do not make a readjustment of the pre-tension of the one spring or of both springs necessary.

Preferably, the energy stored in the respective spring is determined in that the course of the spring force of the spring that results during the compression of this spring is detected and integrated over the path length or distance corresponding to the compression.

In an advantageous embodiment of the method, the pre-tension of the one spring or of both springs is adjusted in such a manner so that the same energy is stored in both springs due to their compression resulting from the armature motion.

Hereby one achieves that the armature, if it is released from its two end positions and oscillates freely, approaches equally close to the respective oppositely located end positions. As a result of this, the influence of production-caused tolerances of the components, especially of the springs, on the oscillating behavior of the armature is reduced. Additionally, the total energy requirement of the actuator is optimized, because both electromagnets comprise the same current requirement due to the armature approaching equally close thereto. Namely, if the armature, during free oscillation, would approach closer to the one electromagnet than the other, then the current requirement of the one electromagnet would be reduced by a certain amount, whereas, however, the current requirement of the other electromagnet would increase by a multiple of this amount, so that also the total energy requirement of the actuator would increase relative to the optimal value.

A preferred example embodiment of the invention is described in greater detail in the following, in connection with the drawings, wherein:

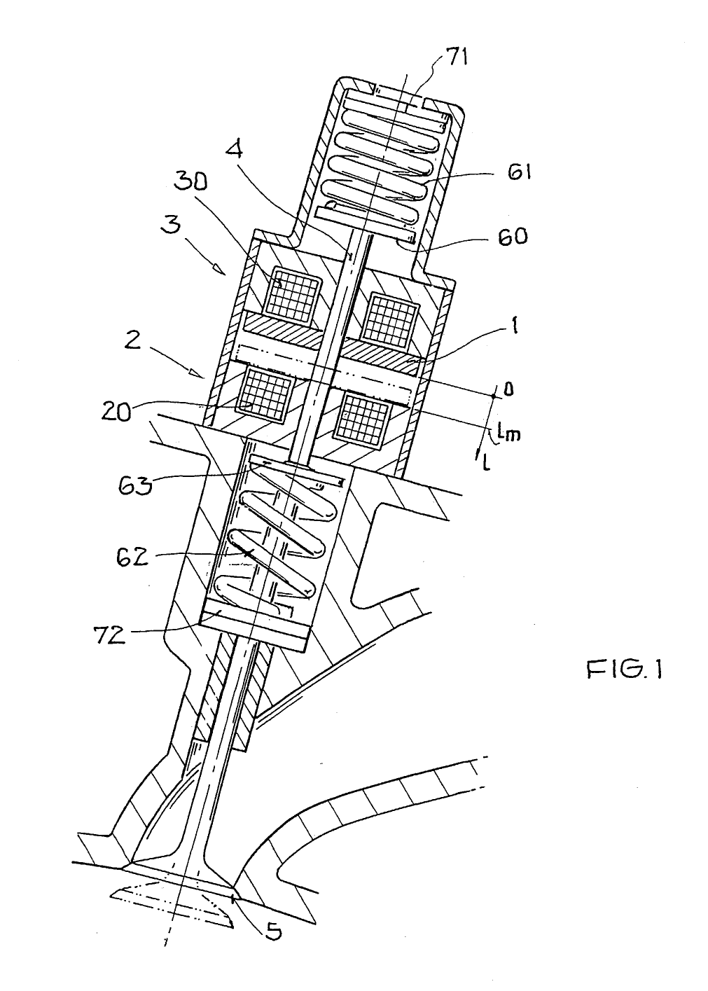

FIG. 1 shows a general principle illustration of an electromagnetic actuator for operating a gas exchange valve in an internal combustion engine,

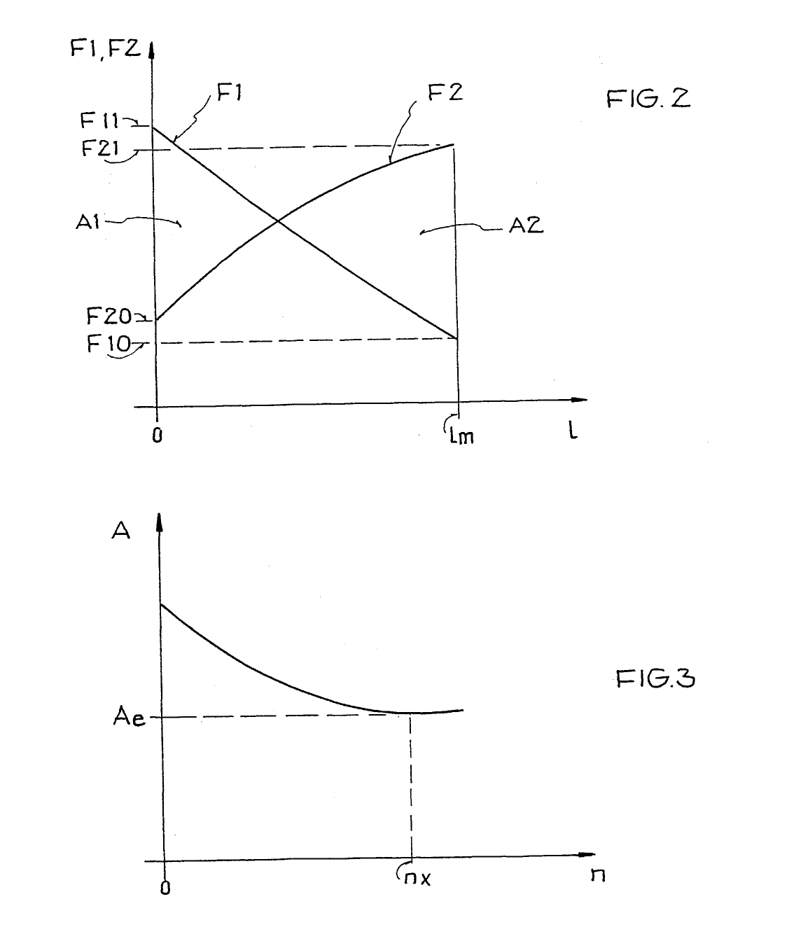

FIG. 2 shows a force-displacement diagram for the spring forces of two springs of the actuator of FIG. 1,

FIG. 3 shows the energy stored in a spring dependent on the number of compression cycles.

According to the FIG. 1, the actuator comprises a pushrod 4 operatively connected with a gas exchange valve 5, an armature 1 secured with the pushrod 4 perpendicularly to the pushrod longitudinal axis, an electromagnet 3 acting as a closing magnet, as well as a further electromagnet 2 acting as an opening magnet, which is arranged spaced apart from the closing magnet 3 in the direction of the pushrod longitudinal axis. The electromagnets 2, 3 respectively comprise an exciting or energizing coil 20 or 30 and mutually oppositely located pole surfaces. By alternately supplying current to the two electromagnets 2, 3, that is to say the energizing coils 20 or 30, the armature 1 is moved back and forth between the electromagnets 2, 3 along a stroke path limited by the electromagnets 2, 3. A spring arrangement with a first spring 61 that acts via a first spring retaining disk 60 on the armature 1 in the opening direction and a second spring 62 that acts via a second spring retaining disk 63 on the armature 1 in the closing direction achieve that the armature 1 is held in a balanced or equilibrium position between the electromagnets 2, 3 in the unenergized current-less condition of the energizing coils 20, 30. Furthermore, adjusting means 71, 72 for adjusting the pre-tension of the springs 61, 62 are provided. The adjusting means 71, 72 may, for example, be embodied as disks that effectuate a compression of the springs 61, 62 and thus prescribe the pre-tension of the respective springs 61, 62. They can, however, also be embodied controllably and enable a continuous or stepless variation of the pre-tension.

For starting the actuator, one of the electromagnets 2, 3 is energized with a current, that is to say switched on, by applying an exciting or energizing voltage to the corresponding energizing coil 20 or 30, or a start-up transient oscillation routine is initiated, through which the armature 1 is first set into oscillation by alternating application of current to the electromagnets 2, 3 in order to strike against the pole surface of the closing magnet 2 or the pole surface of the opening magnet 3 after a start-up transient time.

With a closed gas exchange valve 5, the armature 1 lies against the pole surface of the closing magnet 3 as shown in FIG. 1, and it is held in this position—the upper end position or closing position—as long as the closing magnet 3 is supplied with current. In order to open the gas exchange valve 5, the closing magnet 3 is switched off and then the opening magnet 2 is supplied with current. The first spring 61 which acts in the opening direction accelerates the armature 1 through and past the resting position. By means of the opening magnet 2, which is now supplied with current, additional kinetic energy is supplied to the armature 1, so that it reaches the pole surface of the opening magnet 2 despite possible frictional losses, and there the armature 1 is held at the lower end position or open position as shown with dashed lines in FIG. 1 until the opening magnet 2 is switched off. For once again closing the gas exchange valve 5, the opening magnet 2 is switched off and the closing magnet 3 is then once again switched on. Thereby, the armature 1 is moved by the second spring 62 to the closing magnet 3, and there is held on its pole surface in the closing position.

The stroke path distance or displacement Im of the armature 1, that is to say the path distance that the armature 1 traverses during its motion—the motion of the armature 1 will be designated in the following as the flight—, is limited due to the prescribed spacing distance between the electromagnets 2, 3. The courses or progressions of the spring forces of the two springs 61, 62, that is to say the forces with which the springs 61, 62 act on the armature 1, are dependent on the armature position I and can be described in connection with spring characteristic curves or functions. In the force-displacement diagram in FIG. 2, the spring characteristic curve or function of the first spring 61 is referenced with Fl, and the spring characteristic curve or function of the second spring 62 is referenced with F2. In the present example embodiment, different springs are used; their spring characteristic curves or functions thus differ from one another. However, it is also conceivable to use equivalent springs.

During the flight of the armature 1 from the upper end position to the lower end position, that is to say from the armature position 0 to the armature position Im, the force of the first spring 61 diminishes or falls off from a holding value F11 to an end value F10, which is reached at the armature position Im, that is to say with the armature 1 lying against the opening magnet 2. The spring force of the second spring 62, in comparison, rises or increases from an end value F20 effective in the upper end position of the armature 1 to a holding value F21 which is reached in the lower end position of the armature 1. The end values F10, F20 specify the pre-tension of the respective springs 61 or 62, and the surface areas A1 and A2 below the spring characteristic curves or functions F1 or F2 correspond to the energy that is stored in the respective spring 61 or 62, when these are compressed due to the armature motion by the amount I=Im.

Due to the setting or settling of the springs 61, 62 and of the moved parts of the actuator, especially due to the setting or settling of wedges, by means of which the second spring retaining disk 63 is connected with the gas exchange valve 5, which setting or settling arises during the operation, the pre-tension of the springs diminishes or falls off, which leads to a shifting of the spring characteristic curves or functions F1, F2 and therewith to a reduction of the surface areas A1, A2 under the spring characteristic curves or functions F1, F2. That also means, however, that the energy that is respectively stored in the springs 61, 62 by means of the compression thereof resulting from the armature motion, is reduced with the increasing number of the compression cycles.

FIG. 3 shows the connection or relation between the energy A stored in a spring and the number n of compression cycles in which the spring is respectively compressed by the same value. It is apparent that the energy A diminishes with increasing number n of the compression cycles and thereby asymptotically approaches an end value Ae. After a certain number nx of compression cycles, the energy A is nearly equal to the end value Ae and the setting process can be regarded as completed.

In order to enable an adjustment of the pre-tension of the two springs 61, 62 that is optimal for the operation of the actuator according to the specified conditions, it is necessary to ensure that the spring characteristic curves or functions F1, F2 do not shift during the operation. One achieves this in that during the production of the actuator, first a partial assembly is carried out, in which the first spring 61 is installed into the part enclosing the electromagnets 2, 3 and the armature 1 and the second spring 62 is installed with the gas exchange valve 5 and the second spring retaining disk 63 in the cylinder head of the internal combustion engine, and in that the springs in these partial assemblies are compressed independently from one another in repeating compression cycles respectively by a certain compression value, whereby the compression cycles are repeated so often until the setting process is completed. The compression value in this context is selected to be equal to that value by which the springs 61, 62 are compressed during the operation of the actuator according to the prescribed conditions.

As an alternative thereto, the armature 1 can also be moved back and forth in repeating motion cycles, which correspond to the compression cycles of the springs 61, 62, between its end positions 0, Im prescribed by the electromagnets 2, 3, so often until the setting process is completed, with a completely assembled and thus ready-for-operation actuator when placing the actuator into operation, that is to say before the operation according to the prescribed conditions. In that regard, the armature 1 can be set into motion by the magnetic force of the electromagnets 2, 3 or by external force influence.

The energy A1, A2 that is stored in the respective spring 61 or 62 due to its compression is determined in the successive compression cycles. In this context, the determination of the energy A1 or A2 is achieved in that the spring force F1 or F2 arising during the motion of the armature is measured section-wise and integrated section-wise over the spring displacement path or travel distance. The measurement of the spring force F1 or F2 can be carried out by means of a load cell or a dial gage, but also with other pressure sensors, especially with piezoelectric crystals. If the difference between the energy A1 or A2 determined in the present compression cycle and the energy determined in a preceding compression cycle for the same spring 61 or 62 is smaller than a prescribed value, then this is an indication that the setting process is completed. Thus, the compression cycles are repeated so often until the energy A1 or A2 that is stored in the respective spring 61 or 62 due to the spring compression resulting from the armature motion no longer differs or only insignificantly differs, that is to say by a value that is negligible in the scope of the measuring accuracy, from the energy that is stored in the respective spring 61 or 62 in a preceding compression cycle.

Through the comparison of the energies A1 or A2 stored in the respective springs 61 or 62 in successive compression cycles it is possible to determine the time point at which the setting process is completed or ended, in order to then next carry out the adjustment of the pre-tension of the first and/or second spring 61 or 62 that is optimal for the operation according to the prescribed conditions. With respect to the energy requirement, an adjustment has been shown to be optimal, which leads to the result that the same energy A1, A2 is stored in the two springs 61, 62, if the springs 61, 62 are respectively compressed by the travel distance or displacement corresponding to the stroke path distance Im.

1. Method for producing an electromagnetic actuator, which comprises two electromagnets (2, 3) arranged at a spacing distance relative to one another, and an armature (1) that is movable back and forth between the electromagnets (2, 3) against the force of two oppositely acting springs (61, 62), characterized in that the springs (61, 62) are compressed by a certain compression value in repeating compression cycles so often until the energy (A1, A2) stored in each spring (61, 62) due to its compression no longer or only insignificantly differs from the energy stored in the respective spring (61, 62) in a preceding compression cycle, and in that, following thereafter, an adjustment of the pre-tension (F10, F20) of one of the springs (61, 62) or of both springs (61, 62) is carried out.

2. Method according to claim 1, characterized in that the certain compression value is selected equal to the value by which the springs (61, 62) are compressed during the operation of the actuator.

3. Method according to claim 1 or 2, characterized in that the energy (A1, A2) stored in the springs (61, 62) is determined, in that the course of the spring force (F1, F2) arising through the compression of the respective spring (61, 62) is detected and integrated over the travel displacement corresponding to the compression.

4. Method according to one of the preceding claims, characterized in that the pre-tension (F10, F20) of the one spring or of both springs (61, 62) is adjusted so that the same energy (A1, A2) is stored in both springs (61, 62) due to their compression.
